(19) United States
(12) Patent Application Publication
(10) Pub. No.: US 2010/0275724 A1
(43) Pub. Date: Nov. 4, 2010

(54) INSERT FOR BICYCLE CRANK ARM

(75) Inventors: Jonathan S. STAPLES, New Westminister (CA); Paul A. SIDLICK, Campbell River (CA)

Correspondence Address: FASKEN MARTINEAU DUMOULIN LLP, 2900 - 550 Burrard Street, VANCOUVER, BC, V6C 0A3, CA

(73) Assignee: RACE FACE COMPONENTS INC., New Westminister, BC (CA)

(21) Appl. No.: 12/432,681

(22) Filed: Apr. 29, 2009

(51) Int. Cl. B62M 3/00; B29C 44/12

(52) U.S. Cl. 74/594.1; 264/274

(57) ABSTRACT

A crank arm is provided, having a body made of a composite material, the body defining two apertures, each aperture defining a plurality of recesses. Each of the recesses extends outwardly a distance from a center of the corresponding aperture and widens as the distance increases. Inserts made of a material surrounding the inside edge of each aperture, and each insert has extensions fitting within a corresponding recess. When the crank arm is cooled, the material shrinks relative to the body, and the recesses maintain the insert in position during the cooling process.

### TECHNICAL FIELD

The present invention relates to a bicycles, and more particularly to a composite crank arm for a bicycle.

### BACKGROUND OF THE INVENTION

A typical bicycle crank and bottom bracket assembly consists of a bearing assembly attached to a bottom bracket hanger shell of a bicycle frame. The bearing assembly supports a spindle inserted through the inner periphery of the bearing assembly which allows it to rotate about the bearing assembly's axis. Two crank arms are provided, each of which have, at one end, means to be attached to the spindle from each side of the bearing assembly, although the spindle may be moulded to such crank arm. The other end of each crank arm includes means for attaching pedals, to which force is applied when in use to rotate the bearing assembly about the spindle. In a hollow composite crank there are typically inserts at each end of the crank arm that are made of a dissimilar material to that of the composite.

During the moulding process the crank arm, after being heated to temperatures that are often more than 100° C. above room temperature, then cools. Inserts, made of material such as aluminum, steel or titanium, shrink more then the surrounding crank arm composite material, typically carbon fiber, as the crank cools. This dissimilar shrinkage leaves small gaps on all sides of the insert. As the insert is loaded during its service life, the insert rocks back and forth thereby abrading the carbon fibre and increasing the sizes of the gaps. Eventually the insert becomes noticeably loose and the part must be taken out of service.

Attempts to solve this problem include: roughening the surface of the insert; gluing the insert in place; adding flat portions or flanges that act as anti-rotation features; adding double threaded features (right hand and left hand threads on the same part) on the insert; using a continuous spine that connects two inserts together, and combinations of the above. These solutions are inadequate for the following reasons:

Roughening the surface does not address the issue of the dissimilar shrinkage. This solution only delays failure, and the rough surface could expedite the rate of abrasion once the insert starts to move when being used.

Gluing or bonding the insert in place does not address the issue of dissimilar shrinkage. The glue acts as shear layer that helps fill a gap but is awkward to apply to the insert during the moulding process.

Adding flat portions or parallel flanges; flat portions work as an anti-rotation feature but do not address the issue of dissimilar shrinkage. Parallel flanges take advantage of the dissimilar shrinkage by squeezing the material between the flanges during shrinkage but as the flanges are parallel the only holding power of the insert is surface friction

Double threaded features do not address the issue of dissimilar shrinkage. This solution loads the carbon fibre surrounding the insert through the threads when the insert is turned in either direction. This method of loading the carbon fibre abrades the carbon in the same manner as other insert movements within a gap created by dissimilar shrinkage.

Continuous spine does not address the issue of dissimilar shrinkage. This solution also adds excess weight to the crank arm.

### SUMMARY OF THE INVENTION

The apparatus according to the invention provides a means whereby a material that is dissimilar to carbon fibre may be bonded securely within the carbon fibre, and in particular may be used to provide a robust interface between an aluminium insert and carbon fibre composite material.

This apparatus and method according to the invention eliminate the gap surrounding the majority of the insert by using a series of widening recesses. This takes advantage of the dissimilar rate of shrinkage between the two materials to bias the insert in the appropriate direction as it shrinks. The holding power of the insert then becomes more then just the surface friction, and increases as the insert moves when being used.

A crank arm is provided, including: a body made of a composite material defining an aperture having a plurality of recesses, each of the recesses having an opening, and at least one of the recesses having a width from a first side of the recess to a second side of the recess exceeding the length of the opening; an insert made of a material surrounding the inside edge of the aperture, the insert having a plurality of extensions, each of the extensions fitting within a corresponding recess; wherein the material shrinks relative to the composite material during cooling of the crank arm.

A method of cooling a crank arm during the moulding process is provided, including the steps of: a) providing an insert made of a material, the insert defining an aperture, the insert having a plurality of extensions, each of the extensions fitting within a corresponding recess, wherein the neck of the insertions is narrower than a distance between a first side of the insertion and a second side of the insertion; b) heating the crank arm whereby composite material cures around the extensions, thereby defining a crank arm having a body made of the composite material, the body defining a plurality of recesses, each of the recesses having an opening, and at least one of the recesses having a width from a first side of the recess to a second side of the recess exceeding the length of the opening; c) cooling the crank arm, whereby the material shrinks relative to the composite material during cooling of the crank arm.

### DRAWINGS

The following figures set forth embodiments of the invention in which like reference numerals denote like parts. Embodiments of the invention are illustrated by way of example and not by way of limitation in the accompanying figures.

FIG. 1 is an isometric view of a crank arm;

FIGS. 2a and 2b are front cross-sectional views of a portion of the crank arm according to the invention both before and after the cooling process; and

FIGS. 3a and 3b are a side cross-sectional views of a portion of the crank arm both before and after the cooling process; and

FIG. 4 is a front cross sectional view of a portion of the crank arm according to the invention with the insert not shown for clarity.

### DETAILED DESCRIPTION OF EMBODIMENTS OF THE INVENTION

The apparatus and system according to the invention uses a series of widening recesses within a crank arm to mechanically lock an insert to the carbon fibre during the cooling that takes place after the moulding process. As the insert shrinks it follows the recess wall of the hollow made by the insert rather then shrinking away from it. The insert angle can be chosen to be equal to, greater than or less than the angle of shrinkage at any particular location of the insert. Changing the angle changes the gap (or interference) produced during the shrinkage thereby changing the locking characteristics and allowing the crank arm to be optimized for a given loading.

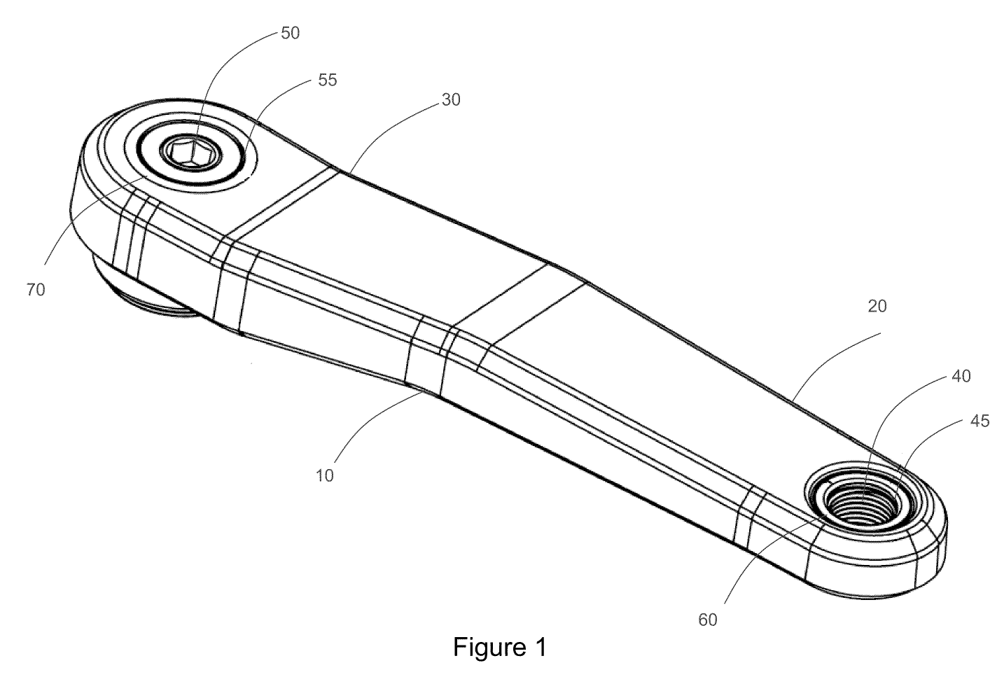

Referring to FIGS. 1, 2a, 2b, 3a, 3b and 4, a crank arm 10 is generally shown. The crank arm 10, typically made of carbon fiber or other composite material, such as fiberglass, Kevlar, boron fiber or beryllium fiber, has a first end 30 and a second end 20. The first end 30 has aperture 50 surrounded by insert 70 and the second end 20 has aperture 40 surrounded by insert 60. Apertures 40, 50 are generally circular and have edges 45, 55 respectively. Inserts 60, 70 surround the edge 45, 55 of apertures 40, 50 respectively.

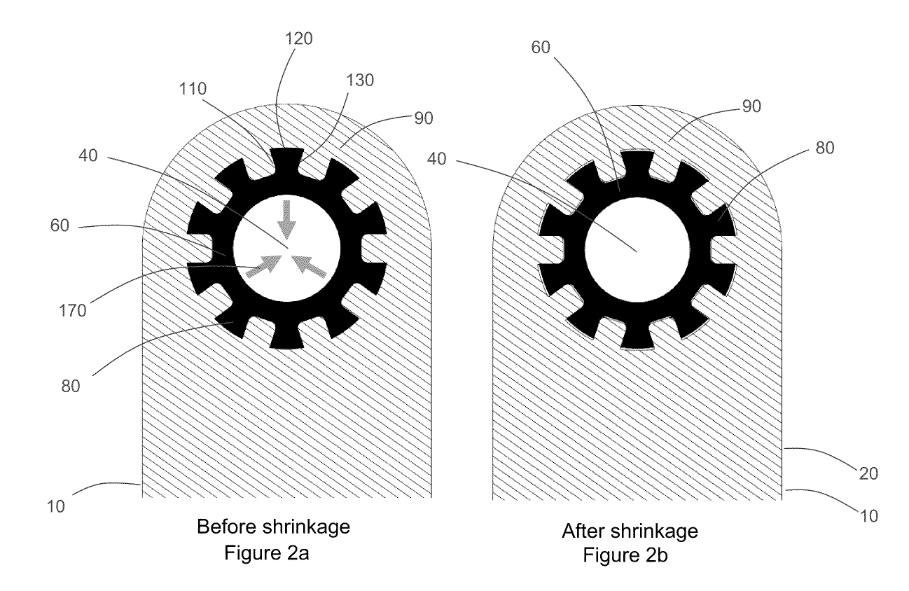

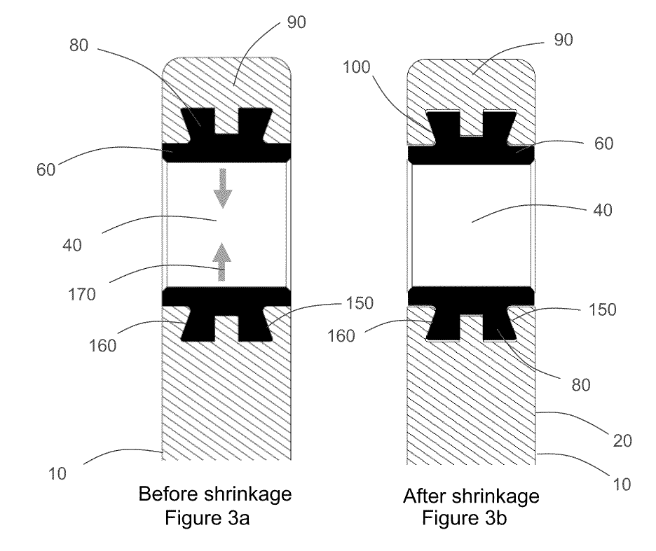

Inserts 60, 70 are typically made of a material such as aluminum, titanium or steel. When assembled on a bicycle, the first end 30 of the crank arm 10 is coupled to a spindle of a bicycle crank and bottom bracket assembly (not shown) by passing the spindle through aperture 50, and the second end 20 is coupled to a spindle body and pedal (not shown) by passing the spindle body through aperture 40. The inserts 60, 70 have extensions 80, as seen in FIGS. 2a, 2b and 3a and 3b, which fit into recesses 85 defined by apertures 40, 50, and are surrounded on three sides 110, 120 and 130 by composite material 90 and by upper edge 150 and lower edge 160 as seen in FIGS. 3a and 3b. Neck 81 of insertions 80 is narrower than a distance between sides 82 and 83. Optionally insertions can be of a different shape, such as a sphere or pyramid, so long as a width within insertion 80 is larger than neck 81.

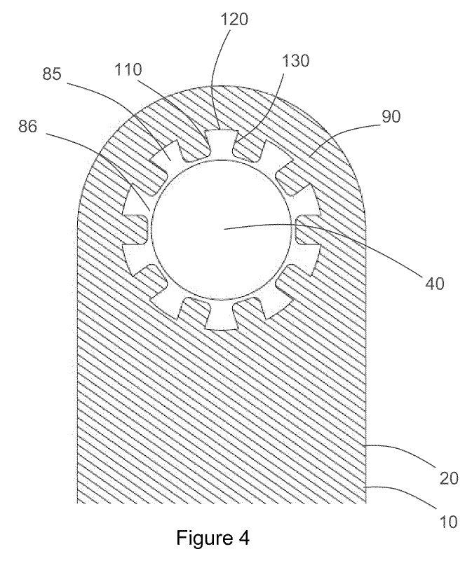

As seen in FIGS. 2 and 4, recesses 85 are wider from side 110 to side 130 away from the center of aperture 40, 50 relative to the opening 86 of such recess 85, so that each recess 85 corresponds to an insertion 80. In an embodiment of the invention recess 85 widens in a symmetric pattern, until base side 120 is at a 72° to 79° angle to sides 110 and 130, or is within a range of a 35° to 89° angle to sides 110, or even 1° to 89°. Optionally, recess 85 may be a different shape, such as a sphere with an opening 86, or an asymmetric pyramid so long as an interior width of recess 85 exceeds the width of opening 86.

As seen in FIGS. 3a and 3b, there may be a multiplicity of rows 140 of recesses 85 within apertures 40, 50. Rows 140 may be aligned in a parallel manner.

During the moulding process, the composite material 90 cures around the inserts 60, 70 and extensions 80 so that crank arm 10 is defined having a body made of composite material 90 with recesses 85 corresponding to each extension 80. When crank arm 10 cools after moulding, and inserts 60, 70 shrink, thereby pulling extensions 80 inwards in the direction of arrows 170, however, as the width of extension 80 is wider within recess 85 than at neck 86, extensions 80 are locked in place.

The angles of recess sides 110 and 130 to base 120 determine the gap, or interference, that is between the inserts 60, 70 and composite material 90, allowing a designer to modify the holding characteristics of inserts 60, 70.

Because of the widening shape of extensions 80, the holding power of apertures 40, 50 is greater than the surface friction between two parallel sides of inserts. The holding power will increase as the inserts 60, 70 are loaded when in use.

Inserts 60, 70 may be made with common materials used in the bicycling industry, including aluminum, titanium; steel, magnesium, stainless steel, or various plastics such as polyurethane, polypropylene, or polycarbonate.

The crank arm 10 according to the invention provides several advantages for the bicycle rider. The rider will experience less downtime as a result of loosened inserts 60, 70 and will thereby be more satisfied with the product.

Crank arm 10 will also reduce the number of bike manufacturer warranty claims for loosening failures resulting from riding.

While the figures detail the insert in relation to second end 20, the same principles apply to aperture 50 at first end 30.

Specific embodiments have been shown and described herein. However, modifications and variations may occur to those skilled in the art. All such modifications and variations are believed to be within the scope and sphere of the present invention.

1. A crank arm, comprising:
a body made of a composite material, said body defining an aperture, said aperture defining a plurality of recesses, each of said recesses having an opening, and at least one of said recesses having a width from a first side of said recess to a second side of said recess exceeding the length of said opening;
an insert made of a material surrounding the edge of said aperture, said insert having a plurality of extensions, each of said extensions fitting within a corresponding recess;
wherein said material shrinks relative to said composite material during cooling of said crank arm.

2. The crank arm of claim 2 wherein said body defines a second aperture, said second aperture defining a plurality of recesses, each of said recesses having an opening, each of said second plurality of recesses wherein a width from a first side of said recess to a second side of said recess exceeds the length of said opening;
an second insert made of a material surrounding the inside edge of said second aperture, said second insert having a plurality of extension, each of said extensions fitting within a corresponding recess.

3. The crank arm of claim 2 wherein said composite material is carbon fiber.

4. The crank arm of claim 3 wherein said material is aluminum.

5. The crank arm of claim 3 wherein said material is steel.

6. The crank arm of claim 3 wherein said material is titanium.

7. The crank arm of claim 3 wherein said recesses each have a first edge adjacent a second edge, and said second edge also adjacent a third edge, wherein said first edge is at a 72° to 79° angle to said second edge.

8. The crank arm of claim 7 wherein said third edge is at an 72° to 79° angle to said second edge.

9. The crank arm of claim 8 wherein a plurality of said recesses are defined in a row along said edge of said first aperture.

10. The crank arm of claim 9 further comprising a second row of a plurality of said recesses along said edge of said first aperture.

11. The crank arm of claim 10 wherein a plurality of said recesses are defined in a row along said edge of said second aperture.

12. The crank arm of claim 11 further comprising a second row of a plurality of recesses along said edge of said first aperture.

13. The crank arm of claim 10 wherein said first row of recesses is parallel to said second row of recesses.

14. A method of cooling a crank arm during the moulding process, comprising the steps of:
a) providing an insert made of a material, said insert defining an aperture, said insert having a plurality of extensions, each of said extensions fitting within a corresponding recess, wherein the neck of said insertions is narrower than a distance between a first side of said insertion and a second side of said insertion;
b) heating said crank arm whereby composite material cures around said extensions, thereby defining a crank arm having a body made of said composite material, said body defining a plurality of recesses, each of said recesses having an opening, and at least one of said recesses having a width from a first side of said recess to a second side of said recess exceeding the length of said opening;
c) cooling said crank arm, whereby said material shrinks relative to said composite material during cooling of said crank arm.
